(19) United States
(12) Patent Application Publication
(10) Pub. No.: US 2019/0099954 A1
(43) Pub. Date: Apr. 4, 2019

(54) DETECTING ABNORMAL OPERATION OF MOVING PARTS IN ADDITIVE MANUFACTURING SYSTEMS

(71) Applicants: Xavier Vilajosana, Sant Cugat del Valles (ES); Sebastia Cortes, Sant Cugat del Valles (ES); Pablo Dominguez, Sant Cugat del Valles (ES); Diego Javier Mostaccio, Sant Cugat del Valles (ES); Alejandro Manuel de Pena, Sant Cugat del Valles (ES); HEWLETT-PACKARD DEVELOPMENT COMPANY, L.P., Houston, TX (US)

(72) Inventors: Xavier Vilajosana, Sant Cugat del Valles (ES); Sebastia Cortes, Sant Cugat del Valles (ES); Pablo Dominguez, Sant Cugat del Valles (ES); Diego Javier Mostaccio, Sant Cugat del Valles (ES); Alejandro Manuel de Pena, Sant Cugat del Valles (ES)

(21) Appl. No.: 16/085,492

(22) PCT Filed: Mar. 18, 2016
(86) PCT No.: PCT/EP2016/056059

§ 371 Date: Sep. 14, 2018

(51) Int. Cl. B29C 64/393; B29C 64/165

(52) U.S. Cl. CPC B29C 64/393; B33Y 10/00; B29C 64/165

(57) ABSTRACT

Measures for use in an additive manufacturing system. A thermal camera measures temperatures of a printbed area of the system at a first time and a second, subsequent time during additive manufacture of an object in the printbed area. A controller receives, from the thermal camera, temperature information associated with the measured temperatures at the first time and the second time and processes the received temperature information to determine a first position of a moving part of the system at the first time and a second position of the moving part at the second time. In response to the processing indicating that the moving part has not moved by a sufficient amount between the first time and the second time, the controller determines that the moving part is operating abnormally.

### BACKGROUND

Additive manufacturing systems that generate three-dimensional objects, including those commonly referred to as “3D printers”, have been proposed as a potentially convenient way to produce three-dimensional objects. These systems may receive a definition of the three-dimensional object in the form of an object model. This object model is processed to instruct the system to produce the object using one or more components. This may be performed on a layer-by-layer basis. The processing of the object model may vary based on the type of system and/or the production technology being implemented.

### BRIEF DESCRIPTION OF THE DRAWINGS

Various features of the present disclosure will be apparent from the detailed description which follows, taken in conjunction with the accompanying drawings, which together illustrate certain example features, and wherein:

FIG. 1 is a schematic diagram showing components of an additive manufacturing system according to certain examples;

FIG. 2 is a schematic illustration of a printbed area with an object being printed on a printbed according to certain examples;

FIG. 3 is a schematic illustration of a printbed area with an object being printed on a printbed according to certain examples;

FIG. 4 is a flowchart showing operations performed in an additive manufacturing system according to certain examples;

FIG. 5 is a flowchart showing a method for use in an additive manufacturing system according to certain examples;

FIG. 6 is a schematic illustration of a processing device according to certain examples;

FIGS. 7A-7C are illustrations of thermal images of a printbed while printing according to certain examples; and

FIGS. 8A-8B are illustrations of thermal images of a printbed while printing according to certain examples.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

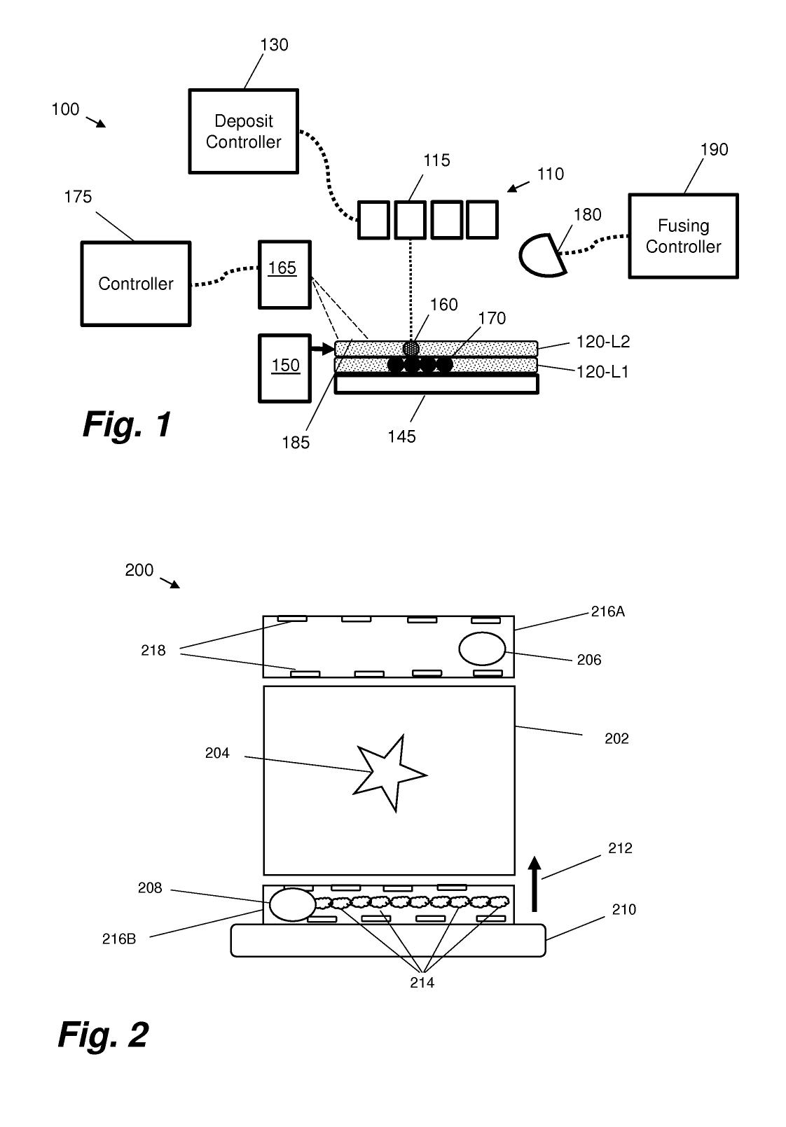

FIG. 1 shows an example of an additive manufacturing system 100 that uses an inkjet deposit mechanism 110 to print a plurality of liquid agents onto layers of a powdered (or slurry, paste, gel, etc.) build material (or ‘substrate’, ‘powder’ or ‘build powder’). Although the examples described herein may be applied to different types of additive manufacturing system, the example of FIG. 1 will be used for ease of reference to further explain some of the concepts disclosed herein.

In FIG. 1, the inkjet deposit or print mechanism 110 implements a deposit mechanism. The deposit mechanism 110 in this example comprises four printheads, such as inkjet printheads, 115, although in other examples, the number of printheads may differ. Examples may involve use of scanning printhead systems and/or page-wide array systems. Each printhead is adapted to deposit an agent onto a build material 120, such as a powdered build material. In particular, each printhead is arranged to deposit a particular agent upon defined areas within a plurality of successive build material layers. An agent may for example act as a coalescing agent (e.g. an energy absorber or fusing agent) or as a coalescing modifier. In FIG. 1, the inkjet print mechanism 110 is communicatively coupled to a deposit controller 130. Further components, may be present but are not shown for clarity.

In FIG. 1, the additive manufacturing system 100 comprises a build material supply mechanism 150 to supply at least one build material layer upon which the plurality of materials are deposited by the deposit mechanism 110. In this example, the build material supply mechanism 150 comprises a powdered build material supply mechanism to supply successive layers of build material. Two example layers are shown in FIG. 1: a first layer 120-L1 upon which a second layer 120-L2 has been deposited by the build material supply mechanism 150. Build material supply mechanism 150 may for example deliver build material from one or more build material storage buckets (not shown) underneath the printbed.

In certain cases, the build material supply mechanism 150 is arranged to move relative to the platen 145 such that successive layers are deposited on top of each other. In certain cases, the build material supply mechanism 150 comprises one or more moving platforms. In certain cases, the build material supply mechanism 150 comprises one or more Archimedes' screws.

In the present example, the additive manufacturing system also comprises a fixing system 180 arranged to apply energy to form portions of the three-dimensional object from combinations of the agents and the build material. For example, FIG. 1 shows a particular printhead 115 depositing a controlled amount of a liquid agent onto an addressable area of the second layer 120-L2 of build material. The print data may be based on an object model, such that the amount and location of liquid agent applied to the layer of build material is based on the object model.

In some examples, fixing system 180 comprises an energy source such as one or more ultra-violet or infra-red light sources, e.g. fusing lamps or lasers. In some examples, fixing system 180 comprises a fusing controller 190 for controlling the fusing process, including controlling the power applied by a fusing energy source such as one or more fusing lamps. Fusing agent may act as an energy absorber such that regions of build material to which fusing agent is applied absorb sufficient fusing energy to exceed the crystallization temperature of the build material and thus fuse. Layer 120-L2 is built on top of lower layer 120-L1. In examples, fusing occurs between layers as well as within layers such that the region 145 of layer 120-L2 to which fusing agent is applied fuses with adjacent region 150 of layer 120-L1 to which fusing agent was applied.

Additive manufacturing system 100 also comprises thermal imaging apparatus 165, for example one or more thermo-cameras (for example infra-red (IR) thermo-cameras). Thermal imaging apparatus 165 uses thermal imaging techniques to measure temperatures on/around the printbed area. In certain examples, thermal imaging apparatus 165 measures temperatures of build material delivery elements, such as build material delivery element 185. In some examples, the build material delivery element comprises a mechanism that forms a layer of build material on a build platform.

Additive manufacturing system also comprises a controller 175 for controlling thermal imaging apparatus 165 and processes associated with detecting abnormal operation of moving parts which are described below.

FIG. 2 is a schematic illustration of a printbed area 200 with an object 204 being printed on a printbed 202 according to certain examples.

During the printing of a 3D part, layers are built successively by printing a 2D cross-section of the part under construction, fusing it and covering the print bed surface with new build material. The covering process is carried out by a moving carriage 210 referred to as a recoater which spreads the material over printbed 202. In one example, the recoater uses a roll or a blade to move build material orthogonally (in the direction of arrow 212 or opposite to the direction of arrow 212) to the printing axis in order to cover the printbed surface with a thin layer of build material. The build material to be moved is accumulated by a build material supply mechanism, for example build material supply mechanism 150 of FIG. 1.

In the examples of FIG. 2, build material supply mechanism 150 comprises two build material delivery receptacles 216A and 216B, at either end of printbed 202. Receptacles 216A and 216B hold build material delivered by the build material supply mechanism 150 before the build material is spread across printbed 202 after each melting phase occurs. Receptacle 216A contains a number of vibrators and/or heaters 218 for spreading and heating build material respectively; receptacle 216B similarly contains a number of vibrators and/or heaters.

The build material (e.g., polyamide powder) is stored in one or more build material storage buckets (not shown) underneath the printbed.

In some examples, build material supply mechanism 150 comprises one or more Archimedes' screws (not shown). In such examples, build material is pumped up to the sides of the printbed using the one or more Archimedes' screws to be stored in receptacles 216A, 216B at the same level of the printbed. The one or more Archimedes' screws pump build material from the bucket(s) to receptacles 216A, 216B on the sides of the printbed. In some examples, one Archimedes' screw delivers build material to receptacle 216A and another Archimedes' screw delivers build material to receptacle 216B.

In some examples, build material supply mechanism 150 comprises one or more moving platforms (not shown). In such examples, the build material is delivered to the sides of the printbed using the one or more moving platforms. In some examples, one moving platform delivers build material to receptacle 216A and another moving platform delivers build material to receptacle 216B.

In certain examples, build material is expulsed by build material supply mechanism 150 through one or more build material delivery elements 206, 208 (for example build material delivery holes) and leveled by vibration of elements 218 over the build material delivery platform.

In certain examples, one or more vane elements (not shown) create piles 214 of build material on the build material delivery platform before spreading by recoater 210. The one or more vanes may for example take the form of one or more hinged doors which open and close to create piles 214 of build material.

The additive manufacturing of an object can take several hours to complete and during that period several situations can occur which may lead to the print process being aborted. A possible failure is caused by the recoater carriage stopping abnormally in a place along its moving path. The cause of such failure can be due to a broken recoater belt which is not detected by the encoders of the motor (because the motor keeps moving). Having the recoater stopped along the bed can cause serious damage to the printer if the printing process is not stopped immediately. Such damage can be in the form of collision of the carriage(s), overheating of the recoater electronics and carriage, overheating of the pens, etc.

Similarly, the powder delivery subsystem can stall in a position such that the recoater carriage can collide with the powder delivery platform or the vanes or suchlike. Again, such collisions can cause serious damage to the powder deliver mechanism and the carriage itself.

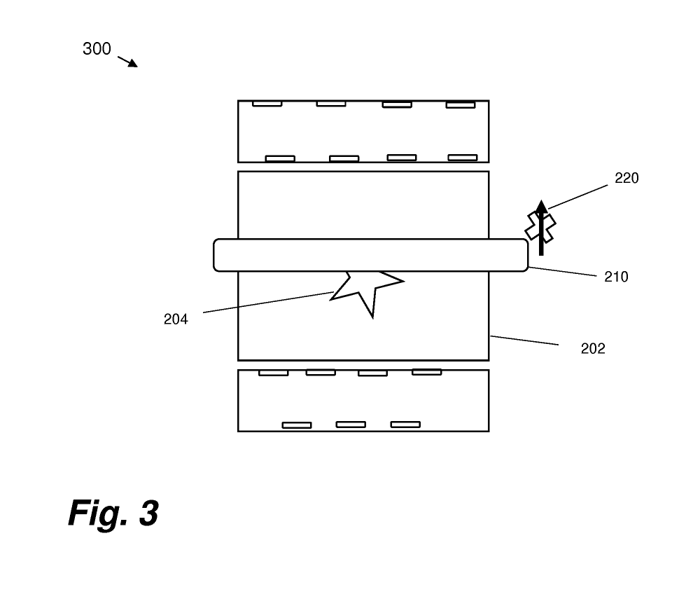

FIG. 3 is a schematic illustration of a printbed area 300 with object 204 being printed on printbed 202 according to certain examples. FIG. 3 depicts a later stage of printing of object 204 than depicted in FIG. 2. In the examples of FIG. 3, recoater 210 can be seen stopped approximately in the middle of printbed 202, i.e. there is no movement in the direction of arrow 220.

Known mechanisms in scan axis printers detect sudden stops of the moving carriages using the motor encoder. Such mechanisms involve detecting too slight variation of successive encoder readings (where more variation of successive encoder readings might be expected for normal movement of the moving part).

According to certain examples, abnormal operation of one or more moving parts (such as the recoater carriage and the powder deliver subsystem) in an additive manufacturing system is detected, thus enabling the immediate stop of the additive manufacturing machine and preventing possible collision(s) or further damage. Certain examples make use of information from thermal imaging apparatus 165, for example one or more thermo-camera sensors.

In certain examples, subsequent thermo-camera images are analyzed and the displacement of moving parts tracked according to the difference between the sampled thermal temperature images and the current layer image being printed. In certain examples, the thermo-camera sampling rate is known and the recoater moving speed is also known and these are used to determine the expected position of the moving part. Thus, if the moving part is not observed at the correct/expected position according to the thermal temperature images, the additive manufacturing machine can be abruptly stopped to prevent damage occurring.

Certain examples detect the abnormal operation of the recoater carriage and/or the powder delivery subsystem. Certain examples enable the detection of sudden stops of the moving part(s) and prevent collision with other moving sources such as the scan axis carriage or the recoater itself. Certain example are able to detect such sudden stops, including in cases where the motor encoders from the moving carriages do not detect the failure. Certain examples therefore allow detection of collisions that would not otherwise be detected.

Certain examples use thermal imaging information to detect the abnormal operation of a moving carriage, powder delivery mechanism or other moving part which moves above the surface of the printbed of an additive manufacturing system.

Certain examples use successive thermo-camera samples from thermal imaging apparatus 165 to determine the position variation of a moving part, for example recoater 21, another moving carriage or a part of build material supply mechanism 150.

Certain examples are able to detect abnormal operation of moving parts as long as printbed 202 has a certain temperature. A factor in being able to distinguish a moving carriage from the rest of the printbed is that the printbed has a different temperature than the surface of the moving carriage (the latter typically being tens of degrees colder).

In certain examples, controller 175 reads data from thermal imaging apparatus 165 continuously to monitor the temperature of the printbed as well as to control the energy delivered to the top heating lamps in order to maintain a stable printbed temperature. At each sample (or a subset thereof), the pixels of the thermal image are analyzed to detect the movement of the moving part (if any).

In certain examples, for each thermal image, a contour detection or edge detection algorithm is applied looking for a dense and massive accumulation of colder pixels.

According to certain examples, in order to avoid any confusion with the current layer being printed, the image being printed is also taken into account.

In certain examples, an edge detection algorithm determines the X, Y position of all those pixels whose temperature is abruptly colder than the average temperature of the printbed. Those colder pixels become candidates to be the moving part (for example recoater or the vanes) being monitored. In some examples, the pixels from the actual image being printed are mapped to the detected pixels in order to filter out the printed objects. In some examples, the shape and/or dimensions of the recoater and/or the position of the vanes are known and the detected cold areas are checked against these reference positions and shapes.

In certain examples, for each of the images, the position of a monitored part is compared with the position of the monitored part in the previous layer or layers. After two or more successive samples, certain examples can decide to abort the printing process if the position of the monitored part has not changed or has not changed sufficiently.

In certain examples, a decision on whether to abort the printing process can be complemented with information coming from the motor encoder (for example information which provides a position with reference to an origin such as a corner of the printbed or suchlike). That is, if the motor encoder is moving, but the colder part does not, this suggests that the part has stalled such that the printing process can be stopped or paused accordingly.

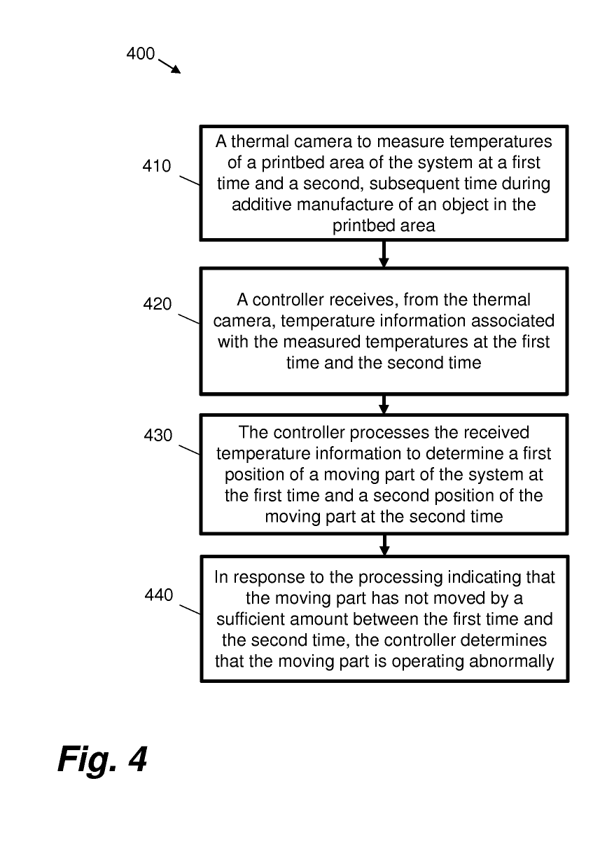

FIG. 4 is a flowchart 400 showing operations performed in an additive manufacturing system according to certain examples.

At block 410, a thermal camera 165 measures temperatures of a printbed area of the system at a first time and a second, subsequent time during additive manufacture of an object 204 in the printbed area.

At block 420, a controller 175 receives, from the thermal camera, temperature information associated with the measured temperatures at the first time and the second time.

At block 430, the controller processes the received temperature information to determine a first position of a moving part 210 of the system at the first time and a second position of the moving part at the second time.

At block 440, in response to the processing indicating that the moving part has not moved by a sufficient amount between the first time and the second time, the controller determines that the moving part is operating abnormally.

In certain examples, the moving part has a different emissivity than that of the printbed 202 of the system, and the processing comprises processing the received temperature information for an indication of the different emissivity.

According to certain examples, the processing comprises processing the received temperature information for a first indication of the different emissivity associated with the first time and first position and a second indication of the different emissivity associated with the second time and the second position.

In certain examples, an indication of the different emissivity indicates that a position of the moving part has been determined.

In certain examples, the processing comprises applying a contour or edge detection algorithm to detect an accumulation of pixels colder than an average printbed temperature.

According to certain examples, the thermal camera measures temperatures of the printbed, the controller receives temperature information associated with the measured printbed temperatures from the thermal camera, and the controller determines the average printbed temperature from the temperature information associated with the measured printbed temperatures received from the thermal camera.

In certain examples, the controller receives information associated with a current layer of the object being manufactured; in such examples, determining that the moving part is operating abnormally is carried out at least in part on the received information associated with the current layer of the object being manufactured. In certain examples, the information associated with a current layer comprises data that was sent to the printer, for example ‘real image data’ defining to the printer the object (and its layers) that is to be printed or a layer of which is currently being printed.

In certain examples, the controller receives information associated with one or more of a shape and a dimension of the moving part; in such examples, determining that the moving part is operating abnormally is carried out at least in part on the received information associated with the one or more of the shape and the dimension of the moving part.

In certain examples, the controller receives information associated with an expected position of the moving part; in such examples, determining that the moving part is operating abnormally is carried out at least in part on the received information associated with the expected position of the moving part.

According to certain examples, the information associated with the expected position of the moving part is received by the controller from a motor encoder of the system.

In certain examples, in response to determining that the moving part is operating abnormally, the controller initiates stopping of the additive manufacturing of the object by the system.

In certain examples, the moving part comprises a part whose movement is above the surface of the printbed of the system. The moving part may for example comprises one or more of a recoater carriage, a build material delivery part, and a vane.

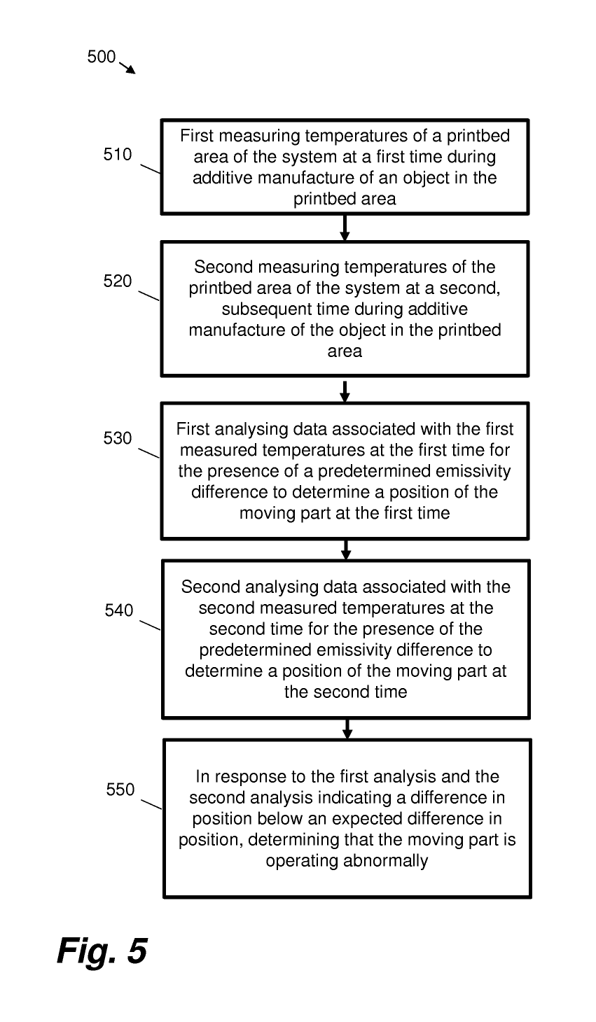

FIG. 5 is a flowchart showing a method 500 for use in an additive manufacturing system according to certain examples.

Block 510 involves first measuring temperatures of a printbed area of the system at a first time during additive manufacture of an object in the printbed area.

Block 520 involves second measuring temperatures of the printbed area of the system at a second, subsequent time during additive manufacture of the object in the printbed area.

Block 530 involves first analyzing data associated with the first measured temperatures at the first time for the presence of a predetermined emissivity difference to determine a position of the moving part at the first time.

Block 540 involves second analyzing data associated with the second measured temperatures at the second time for the presence of the predetermined emissivity difference to determine a position of the moving part at the second time.

Block 550 involves, in response to the first analysis and the second analysis indicating a difference in position below an expected difference in position, determining that the moving part is operating abnormally.

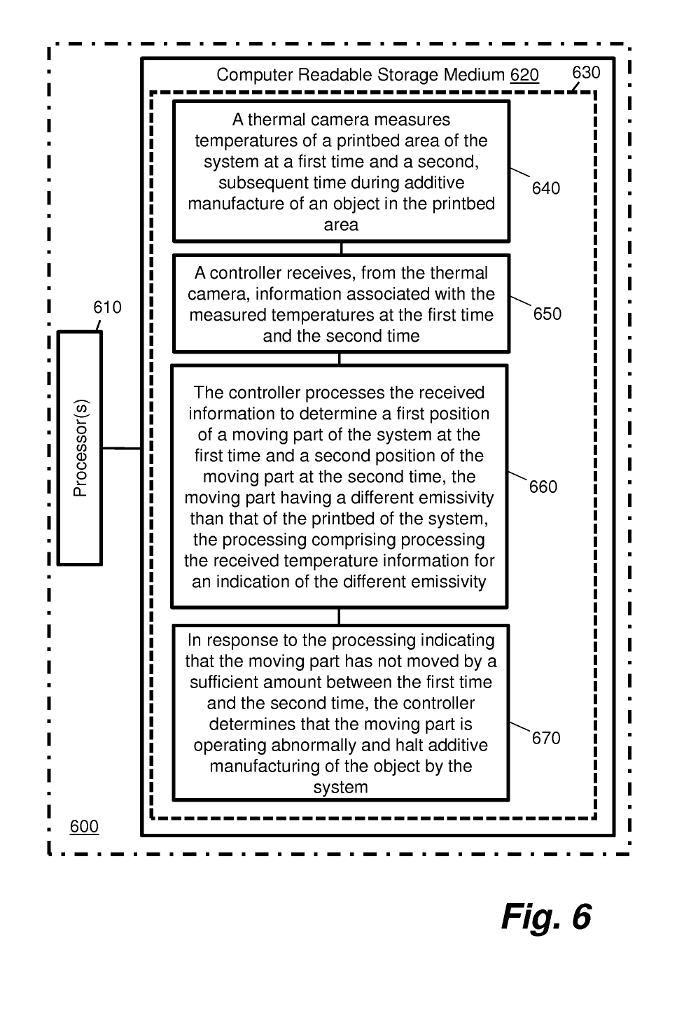

Certain system components and methods described herein may be implemented by way of machine readable instructions that are storable on a non-transitory storage medium. FIG. 6 shows an example of a three-dimensional printing system or device 600 comprising at least one processor 610 arranged to retrieve data from a computer-readable storage medium 620. The computer-readable storage medium 620 comprises a set of computer-readable instructions 630 stored thereon. The at least one processor 610 is configured to load the instructions 630 into memory for processing. The instructions 630 are arranged to cause the at least one processor 610 to perform a series of actions.

Instruction 640 is configured to cause processor(s) 610 to cause a thermal camera to measure temperatures of a printbed area of the system at a first time and a second, subsequent time during additive manufacture of an object in the printbed area.

Instruction 650 is configured to cause processor(s) 610 to cause a controller to receive, from the thermal camera, information associated with the measured temperatures at the first time and the second time.

Instruction 660 is configured to cause processor(s) 610 to cause the controller to process the received information to determine a first position of a moving part of the system at the first time and a second position of the moving part at the second time, the moving part having a different emissivity than that of the printbed of the system, the processing comprising processing the received temperature information for an indication of the different emissivity.

Instruction 670 is configured to cause processor(s) 610 to cause the controller to, in response to the processing indicating that the moving part has not moved by a sufficient amount between the first time and the second time, determine that the moving part is operating abnormally and halt additive manufacturing of the object by the system.

The non-transitory storage medium can be any media that can contain, store, or maintain programs and data for use by or in connection with an instruction execution system. Machine-readable media can comprise any one of many physical media such as, for example, electronic, magnetic, optical, electromagnetic, or semiconductor media. More specific examples of suitable machine-readable media include, but are not limited to, a hard drive, a random access memory (RAM), a read-only memory (ROM), an erasable programmable read-only memory, or a portable disc.

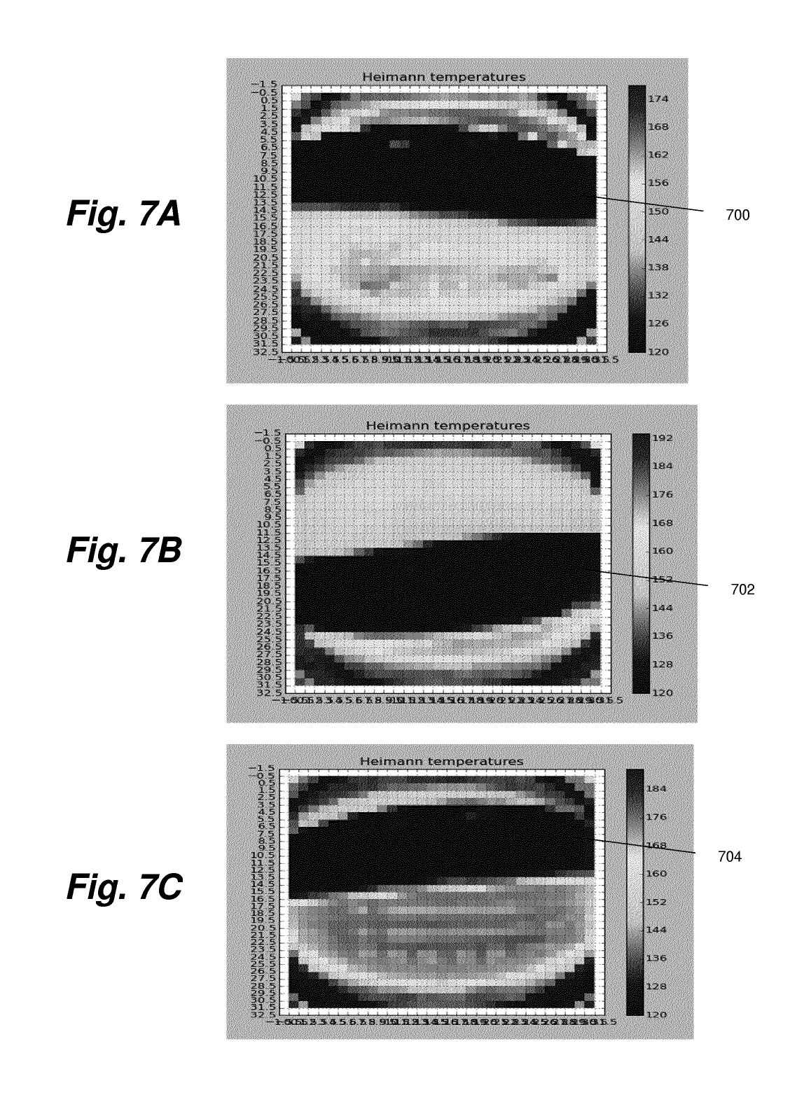

FIGS. 7A-7C are illustrations of thermal images of a printbed while printing according to certain examples. The thermal images may for example have been captured by thermal imaging apparatus 165.

FIGS. 7A-7C show subsequent images taken by the thermal imaging apparatus with the recoater moving back and forth on the printbed. In each case, the recoater can be seen as a ‘bar’ or ‘stripe’ of colder pixels (darker shaded pixels) stretching from left to across the printbed area, labelled 700, 702, 704 in FIGS. 7A-7C respectively.

Consider a comparison of FIGS. 7A and 7B; here, the recoater position can be seen to vary by a not insignificant amount between each image. An analysis of data associated with these images therefore indicates that the recoater is moving, such that an abnormal operation condition would not be triggered according to examples.

Consider a comparison of FIGS. 7A and 7C; here, the recoater position can be seen to not vary at all, or by only a small amount. An analysis of data associated with these images therefore indicates that the recoater is not moving sufficiently or is not moving at all, such that an abnormal operation condition can be triggered according to examples.

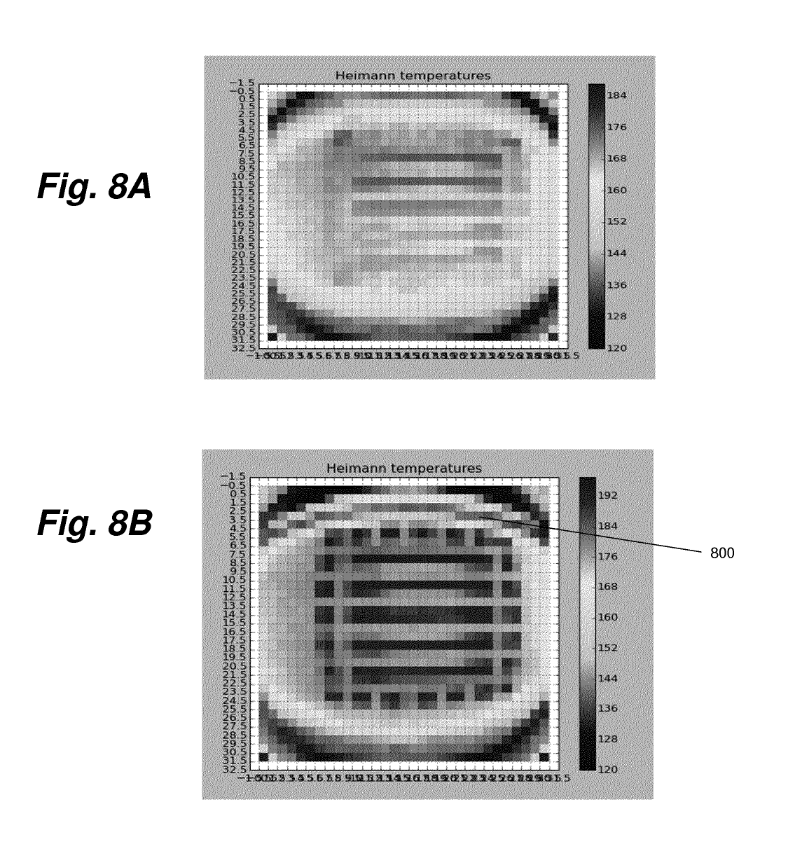

FIGS. 8A-8B are illustrations of thermal images of a printbed while printing according to certain examples. FIGS. 8A-8B show subsequent images taken by the thermal imaging apparatus.

FIG. 8A depicts a situation where the vanes (or vane mechanism) are in a normal operation position such that they are hidden from view.

FIG. 8B shows the vane mechanism in the process of delivering build material to the printbed. In FIG. 8B, the vanes are positioned orthogonally to the print bed surface where they can be seen as a thin line/arc 800 of colder pixels (darker shaded pixels); when in this position, the vanes are above the surface of the printbed so could potentially collide with the recoater mechanism. If the vanes do not subsequently return to a hidden position as per FIG. 8A, then an abnormal operation condition can be triggered according to examples.

Certain examples improve additive manufacturing systems by detecting incorrect operation of the recoater or sudden stalls thereof.

Certain examples improve additive manufacturing systems by detecting incorrect operation of the powder delivery system or sudden stalls thereof.

Certain examples enable avoidance of collisions with other moving elements of the additive manufacturing system.

Certain examples enable prevention of overheating or over-exposure of the recoater to a heat source in case of anomalies.

Certain examples enable pausing and eventual aborting of the printing process if any abnormal situations are detected.

Certain examples comprise an additive manufacturing system, the system comprising a thermal camera to measure temperatures of a printbed area of the system at a first time and a second, subsequent time during additive manufacture of an object in the printbed area, and a controller to receive, from the thermal camera, temperature information associated with the measured temperatures at the first time and the second time, process the received temperature information to determine a first position of a moving part of the system at the first time and a second position of the moving part at the second time, and in response to the processing indicating that the moving part has not moved by an expected amount between the first time and the second time, determining that the moving part is operating abnormally. Such examples enable detection of a moving part which has moved less than expected or detection of a moving part which has moved more than expected.

The preceding description has been presented to illustrate and describe examples of the principles described. This description is not intended to be exhaustive or to limit these principles to any precise form disclosed. Many modifications and variations are possible in light of the above teaching.

1. An additive manufacturing system, the system comprising:
a thermal camera to measure temperatures of a printbed area of the system at a first time and a second, subsequent time during additive manufacture of an object in the printbed area; and
a controller to:
receive, from the thermal camera, temperature information associated with the measured temperatures at the first time and the second time;
process the received temperature information to determine a first position of a moving part of the system at the first time and a second position of the moving part at the second time; and
in response to the processing indicating that the moving part has not moved by a sufficient amount between the first time and the second time, determining that the moving part is operating abnormally.

2. The system of claim 1, wherein the moving part has a different emissivity than that of the printbed of the system, and
wherein the processing comprises processing the received temperature information for an indication of the different emissivity.

3. The system of claim 2, wherein the processing comprises processing the received temperature information for a first indication of the different emissivity associated with the first time and first position and a second indication of the different emissivity associated with the second time and the second position.

4. The system of claim 2, wherein an indication of the different emissivity indicates that a position of the moving part has been determined.

5. The system of claim 1, wherein the processing comprises applying a contour or edge detection algorithm to detect an accumulation of pixels colder than an average printbed temperature.

6. The system of claim 5, wherein the thermal camera measures temperatures of the printbed,
wherein the controller receives temperature information associated with the measured printbed temperatures from the thermal camera, and
wherein the controller determines the average printbed temperature from the temperature information associated with the measured printbed temperatures received from the thermal camera.

7. The system of claim 1, wherein the controller receives information associated with a current layer of the object being manufactured, and
wherein determining that the moving part is operating abnormally is carried out at least in part on the received information associated with the current layer of the object being manufactured.

8. The system of claim 1, wherein the controller receives information associated with one or more of a shape and a dimension of the moving part, and
wherein determining that the moving part is operating abnormally is carried out at least in part on the received information associated with the one or more of the shape and the dimension of the moving part.

9. The system of claim 1, wherein the controller receives information associated with an expected position of the moving part, and
wherein determining that the moving part is operating abnormally is carried out at least in part on the received information associated with the expected position of the moving part.

10. The system of claim 9, wherein the information associated with the expected position of the moving part is received by the controller from a motor encoder of the system.

11. The system of claim 1, the controller to, in response to determining that the moving part is operating abnormally, initiate stopping of the additive manufacturing of the object by the system.

12. The system of claim 1, wherein the moving part comprises a part whose movement is above the surface of the printbed of the system.

13. The system of claim 1, wherein the moving part comprises one or more of:
a recoater carriage,
a build material delivery part, and
a vane.

14. A method for use in an additive manufacturing system, the method comprising:
first measuring temperatures of a printbed area of the system at a first time during additive manufacture of an object in the printbed area;
second measuring temperatures of the printbed area of the system at a second, subsequent time during additive manufacture of the object in the printbed area;
first analysing data associated with the first measured temperatures at the first time for the presence of a predetermined emissivity difference to determine a position of the moving part at the first time;
second analysing data associated with the second measured temperatures at the second time for the presence of the predetermined emissivity difference to determine a position of the moving part at the second time; and
in response to the first analysis and the second analysis indicating a difference in position below an expected difference in position, determining that the moving part is operating abnormally.

15. A non-transitory computer-readable storage medium storing instructions that, if executed by a processor of a three-dimensional printing system, cause:
a thermal camera to measure temperatures of a printbed area of the system at a first time and a second, subsequent time during additive manufacture of an object in the printbed area; and
a controller to:
receive, from the thermal camera, information associated with the measured temperatures at the first time and the second time;
process the received information to determine a first position of a moving part of the system at the first time and a second position of the moving part at the second time, the moving part having a different emissivity than that of the printbed of the system, the processing comprising processing the received temperature information for an indication of the different emissivity; and
in response to the processing indicating that the moving part has not moved by a sufficient amount between the first time and the second time, determine that the moving part is operating abnormally and halt additive manufacturing of the object by the system.
